(19) United States
(12) Patent Application Publication
(10) Pub. No.: US 2025/0292575 A1
(43) Pub. Date: Sep. 18, 2025

(54) VIDEO PROCESSING METHOD AND APPARATUS, AND ELECTRONIC DEVICE

(71) Applicant: Beijing Zitiao Network Technology Co., Ltd., Haidian District, Beijing (CN)

(72) Inventors: Zhe WU, Beijing (CN); Ze WANG, Beijing (CN)

(21) Appl. No.: 18/861,130

(22) PCT Filed: Mar. 31, 2023
(86) PCT No.: PCT/CN2023/085524

§ 371 Date: Oct. 28, 2024

(30) Foreign Application Priority Data
Apr. 28, 2022 (CN) 202210471184.4

(51) Int. Cl. G06V 20/40; G06V 10/56

(52) U.S. Cl. CPC G06V 20/49; G06V 10/56; G06V 20/46

(57) ABSTRACT

The present disclosure relates to the technical field of video processing, and relates to a video processing method and apparatus, and an electronic device. The method comprises: first acquiring key frames, which correspond to transition images, in a video; next, determining splitting nodes for the video according to the key frames corresponding to the transition images; then, splitting the video according to the splitting nodes for the video, so as to obtain video fragments; and finally performing video parallel processing on the basis of the video fragments.

The present application is based on and claims priority to Chinese Application No. 202210471184.4 filed on Apr. 28, 2022, the disclosure of which is incorporated by reference herein in its entirety.

### TECHNICAL FIELD

The present disclosure relates to the field of video processing technologies, and in particular a video processing method and apparatus, and an electronic device.

### BACKGROUND

Video authors can upload videos through video platform websites so as to share them with other users for viewing, and the video platform websites will perform a series of processings for the uploaded videos so as to play them in different application scenes.

### SUMMARY

The present disclosure provides a video processing method and apparatus, and an electronic device.

According to a first aspect, the present disclosure provides a video processing method, which can be applied to a server, comprising:
acquiring key frames corresponding to transition images in a video;
determining split nodes of the video according to the key frames corresponding to the transition images;
splitting the video according to the split nodes of the video so as to obtain video fragments;
performing video parallel processing on the basis of the video fragments.

According to a second aspect, the present disclosure provides another video processing method, which can be applied to a client, comprising:
acquiring video fragments of a video, wherein the video fragments are obtained by splitting the video according to split nodes which are determined according to key frames corresponding to transition images in the video;
playing the video according to the video fragments.

According to a third aspect, the present disclosure provides a video processing apparatus, which can be applied to a server, comprising:
an acquisition module configured to acquire key frames corresponding to transition images in a video;
a determination module configured to determine split nodes of the video according to the key frames corresponding to the transition images;
a splitting module configured to split the video according to the split nodes of the video so as to obtain video fragments;
a processing module configured to perform video parallel processing on the basis of the video fragments.

According to a fourth aspect, the present disclosure provides another video processing apparatus, which can be applied to a client, comprising:
an acquisition module configured to acquire video fragments of a video, wherein the video fragments are obtained by splitting the video according to split nodes which are determined according to key frames corresponding to transition images in the video;
a playback module configured to play the video according to the video fragments.

According to a fifth aspect, the present disclosure provides a computer readable storage medium storing therein computer executable instructions, wherein a processor, when executing the computer executable instructions, implements the video processing method according to the first aspect.

According to a sixth aspect, the present disclosure provides another computer readable storage medium storing therein computer executable instructions, wherein a processor, when executing the computer executable instructions, implements the video processing method according to the second aspect.

According to a seventh aspect, the present disclosure provides an electronic device, which can be specifically a server or a client device, comprising a processor and a memory. The memory stores computer executable instructions. When the electronic device is a server, the processor executes the computer executable instructions stored in the memory, so that the processor executes the video processing method according to the first aspect. When the electronic device is a client device, the processor executes the computer executable instructions stored in the memory, so that the processor executes the video processing method according to the second aspect.

According to an eighth aspect, the present disclosure provides a computer program product comprising a computer program which, when executed by a processor, implements the video processing method according to the first aspect.

According to a ninth aspect, the present disclosure provides another computer program product comprising a computer program which, when executed by a processor, implements the video processing method according to the second aspect.

According to a tenth aspect, the present disclosure provides a computer program comprising computer executable instructions which, when executed by a processor, cause the processor to execute the video processing method according to the first aspect.

According to an eleventh aspect, the present disclosure provides another computer program comprising computer executable instructions which, when executed by a processor, cause the processor to execute the video processing method according to the second aspect.

The above description is only an overview of the technical solution of the present disclosure, which can be implemented according to the contents of the specification in order to understand the technical means of the present disclosure more clearly, and in order to make the above and other purposes, features and advantages of the present disclosure more obvious and understandable, specific implementations of the present disclosure are as follows.

### BRIEF DESCRIPTION OF THE DRAWINGS

The accompanying drawings, which are incorporated in and constitute a part of the specification, illustrate embodiments consistent with the present disclosure and together with the specification, serve to explain the principles of the present disclosure.

In order to explain the technical solutions in the embodiments of the present disclosure or related technologies more clearly, the drawings needed to be used in the description of the embodiments or related technologies will be briefly introduced below. Obviously, for those skilled in the art, other drawings can be obtained according to these drawings without inventive effort.

FIG. 1 shows a schematic flow diagram of a video processing method provided by an embodiment of the present disclosure;

FIG. 2 shows a schematic flow diagram of another video processing method provided by an embodiment of the present disclosure;

FIG. 3 shows a brief flow diagram of video publication provided by an embodiment of the present disclosure;

FIG. 4 shows a schematic diagram of transcoding of split video nodes provided by an embodiment of the present disclosure;

FIG. 5 shows a schematic flow diagram of a further video processing method provided by an embodiment of the present disclosure;

FIG. 6 shows a schematic diagram of an example of video playback provided by an embodiment of the present disclosure;

FIG. 7 shows a schematic diagram of an example of video playback, when a progress bar is dragged, provided by an embodiment of the present disclosure;

FIG. 8 shows a structural schematic diagram of a video processing apparatus provided by an embodiment of the present disclosure;

FIG. 9 shows a structural schematic diagram of another video processing apparatus provided by an embodiment of the present disclosure;

FIG. 10 shows a structural schematic diagram of a video processing system provided by an embodiment of the present disclosure.

### DETAILED DESCRIPTION

At present, if video authors upload videos with a long time length, a large bit rate and a large file size, each link in the video processing chain will take a longer time, more machine resources or manpower, and the like to complete the task of each link. Thus, there will be technical problems of low video processing efficiency and resource consumption.

The present disclosure provides a video processing method and apparatus, and an electronic device. A main purpose is to improve the current technical problems of low video processing efficiency and resource consumption when processing videos with a long time length, a large bit rate and a large file size, which are uploaded by video authors.

Embodiments of the present disclosure will be described in more detail below with reference to the accompanying drawings. It should be noted that the embodiments in the present disclosure and the features in the embodiments can be combined with each other without conflict.

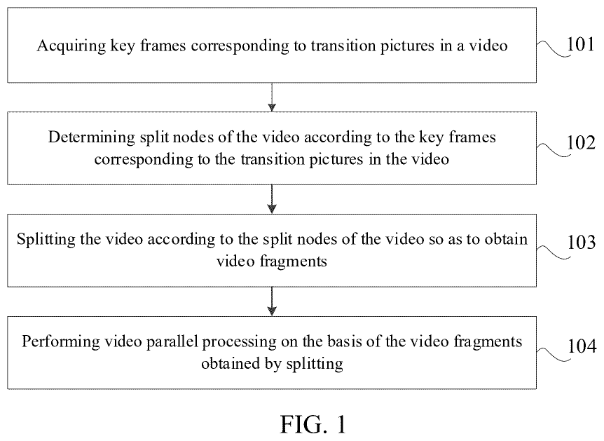

In order to improve the current technical problems of low video processing efficiency and resource consumption present when processing videos with a long time length, a large bit rate and a large file size, which are uploaded by video authors, the present embodiment provides a video processing method, as shown in FIG. 1, which can be applied to a server (such as a server of a video platform website, etc.) side. The method includes:

Step 101, acquiring key frames corresponding to transition images in a video.

The video in the present embodiment can be a video with a long time length, and/or a large code rate, and/or a large resolution, and/or a large file size, or it can also be an ordinary video in addition to that. Whether to use the method of the present embodiment can be selected according to actual requirements.

The key frame corresponding to the transition image can be a frame with a large change degree as compared with a previous frame in the video. For example, the transition images can include: a fade-in and fade-out transition, a fade-out and slow-down transition, an overlapping transition and other images, and the key frames corresponding to the transition images include key frames corresponding to these transition images. Usually, if a transition image occurs in the video, it will generally represent transition and transformation between scenes. By taking the transition image as a reference basis for video splitting, the present embodiment can avoid inappropriate splitting of the video content item of the same scene, and ensure the user's complete viewing experience of the video content item of the same scene as much as possible when viewing the video, thus ensuring the user's video viewing experience.

Step 102, determining split nodes of the video according to the key frames corresponding to the transition images in the video.

The split nodes are nodes where the video needs to be split. The key frame corresponding to each transition image in the video can be regarded as an optional node for video splitting. In the present embodiment, the split nodes of the video can be selected from these optional nodes according to requirements of an actual service scene. For example, the video fragments obtained by splitting need to satisfy certain requirements such as a time length and a file size, and these requirements can be the same or different based on different service scenes. In the present embodiment, according to requirements of an actual service scene, the split nodes of the video can be selected from the key frames corresponding to each transition image, so as to satisfy the requirements for a video time length, a file size and the like in the service scene.

For example, based on a machine learning model, the nodes where the video requires to be split can be determined according to the key frames corresponding to the transition images in the video. The machine learning model can determine the key frames of the whole long video content item, determine transition images by analyzing the key frames, and derive the most suitable time nodes as the split nodes by analyzing in combination with the overall time length, thus ensuring the user experience of the split video.

Step 103, splitting the video according to the split nodes of the video so as to obtain video fragments.

For example, for a video A with a time length of two hours, by analyzing data of the service scene, a better consumption effect can be obtained by splitting the video content into fragments of about 15˜25 minutes. Then, this video A will be analyzed first to determine where its transition images are located in the whole video, and then suitable split points will be found nearby according to a reasonable split threshold to split the video A into: A-1, A-2, A-3, . . . , A-n suitable video fragments.

Step 104, performing video parallel processing on the basis of the video fragments obtained by splitting.

For example, at present, when an author uploads a video with a long time length, a large bit rate and a large file size, each link on the video link will take a longer time, more machine resources and manpower to complete the task of each link. For example, an author publishes two videos, one video A is 3 minutes long and the other video B is 3 hours long. Video B will be slower than video A in each link, and the success rate of each link of video B is not higher than that of video A. Other situations are the same, for example, the bit rate of video A is 10 mbps, and the bit rate of video B is 60 mbps; the resolution of video A is 720P, the resolution of video B is 4K, etc. An increase in such video parameters will result in an increase in time and a reduction in success rate in each link. By means of reasonable video splitting, the present embodiment splits a video with a long time length, a large code rate and a large file size into video fragments with a short time length, unchanged or compressed code rate and a file size not large. Then, based on these video fragments, video parallel processing can be performed, and all links in the video processing chain are optimized, so that the video processing efficiency is greatly increased and the resource consumption can be obviously saved.

Therefore, the present embodiment can effectively solve the current technical problems of low video processing efficiency and high resource consumption present when processing videos with a long time length, a large code rate and a large file size, which are uploaded by video authors. By applying the technical solution of the present embodiment, the processing effect of the whole process from video uploading and post to the final video playback can be optimized as a whole, thus improving the efficiency of the whole video processing flow and reducing the probability of occurrence of video jamming and abnormal failure without affecting the user experience of end content consumers.

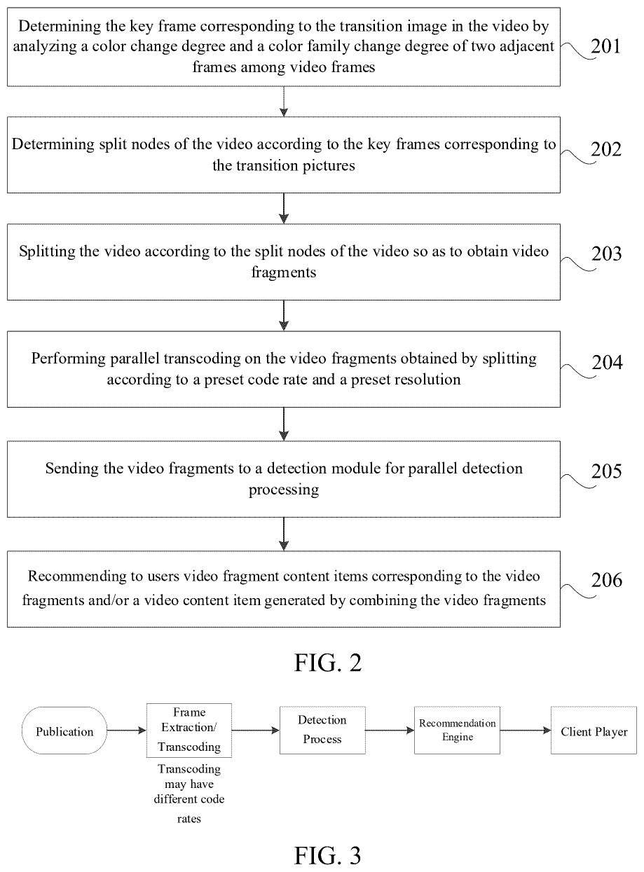

Further, as a refinement and extension of the above embodiment, in order to fully explain the specific implementation process of the method in the present embodiment, the present embodiment provides a specific method as shown in FIG. 2, which can be applied to a server side. The method includes:

Step 201, determining the key frame corresponding to the transition image in the video by analyzing a color change degree and a color family change degree of two adjacent frames among video frames.

In the present embodiment, a machine learning model can be trained based on sample data to realize machine learning of the color change degree and color family change degree of both the previous and next video frames of a video frame when transition images occur in a large number of sample videos, and then use the trained machine learning model to determine the key frames corresponding to the transition images in the current video by analyzing the color change degree and color family change degree of two adjacent frames among video frames. In this way, the key frames corresponding to the transition images in the video can be accurately determined, and the subsequent reasonable video splitting can be ensured.

Optionally, step 201 may specifically include: comparing a color value corresponding to each pixel point in a current frame and in a previous frame; if it is judged according to the comparison result of the color value that the current frame and the previous frame have a color change rate greater than a first preset threshold and a color family change meeting a preset span condition, then determining the key frame corresponding to the transition image according to the current frame.

The color family change meeting the preset span condition requires the two color families before and after the change to have an obvious color family span. However, if the two color families before and after the change do not have an obvious color family span, it means that the color family change does not meet the preset span condition. A specific process of judging whether the color family change meets the preset span condition can include: acquiring a color family a to which a current frame belongs according to a color value corresponding to each pixel point in the current frame, and acquiring a color family b to which a previous frame belongs according to a color value corresponding to each pixel point in the previous frame, so as to determine a color family change from the previous frame to the current frame as a change from the color family b to the color family a. By matching with a color family change with a large color family span (such as a change from color family m to color family n, a change from color family n to color family m, a change from color family x to color family y, and etc., each of which is a color family change with a large color family span) as recorded in a preset storage location (such as a preset database, list, and the like), if a change from color family b to color family a belongs to a color family change with a large color family span as recorded in the preset storage location, it means that the two color families before and after the change have an obvious color family span, and thus it is judged that a color family change between the current frame and the previous frame meets the preset span condition. On the contrary, if a change from color family b to color family a does not belong to a color family change with a large color family span as recorded in a preset storage location, then it means that the two color families before and after the change do not have an obvious color family span, and thus it is judged that the color family change between the current frame and the previous frame does not meet the preset span condition.

For example, if the color family of a video frame changes from dark green to light green, there is no obvious color family span. In the above-mentioned judgement way, it can be judged that the color family change does not meet the preset span condition. In contrast, if dark green is changed to red, there is an obvious color family span. In the above-mentioned judgement way, it can be judged that the color family change meets the preset span condition.

In the present embodiment, both the first preset threshold and the preset span condition can be preset according to the actual requirements. Each pixel point in the current frame is compared with the corresponding pixel point in the previous frame in terms of a color value. If the current frame and the previous frame have a color change rate greater than a certain threshold and a color family change meeting the preset span condition, then the current frame can be determined as the key frame corresponding to the transition image.

However, in actual applications, there may be a situation where an abnormality occurs in a single video frame. Therefore, in order to accurately determine the key frame corresponding to the transition image, further optionally, the above determining the key frame corresponding to the transition image according to the current frame can specifically include: if each of a predetermined number (which can be preset according to an actual situation, such as 1-3) of frames following the current frame and the previous frame (the previous frame of the current frame) have a color change rate greater than a second preset threshold (which can be the same as or different from the above-mentioned first preset threshold) and a color family change meeting a preset span condition, then determining the current frame as a key frame corresponding to the transition image.

For example, if the current frame and the previous frame have a color change rate greater than a certain threshold and a color family change meeting the preset span condition, and some frames following the current frame and the previous frame have a color change rate greater than a certain threshold and a color family change meeting the preset span condition, then it means that the current frame is the key frame where the transition image occurs. In this optional way, the occurrence of misjudgment of key frames of transition images can be reduced, and the accuracy of determining key frames corresponding to transition images can be improved.

Step 202, determining split nodes of the video according to the key frames corresponding to the transition images.

Optionally, step 202 can specifically include: determining split nodes of the video according to the key frames corresponding to the transition images and a preset time length range of each fragment. In this optional way, by means of analyzing on the basis of the transition images in the video in combination with the overall time length of the video, the most suitable time nodes that can satisfy the service requirements are derived as the split nodes, thus ensuring the user experience of the video after splitting.

In different service scenes, the preset time length range of a single fragment can be the same or different. For example, in order to satisfy the requirements of service scene A, the preset time length range of a single fragment can be 5 minutes to 10 minutes, while in order to satisfy the requirements of service scene B, the preset time length range of a single fragment can be 15 minutes to 25 minutes.

Illustratively, determining the split nodes of the video according to the key frames corresponding to the transition images and a preset time length range of each fragment can specifically include: determining, based on the key frames corresponding to the transition images, split nodes meeting a first preset condition as split nodes of the video, so that a video time length of each video fragment obtained by splitting according to the split nodes meeting the first preset condition is within the preset time length range. In the present embodiment, whether the first preset condition is met can be judged by referring to two factors, namely the transition images and the time length of the video fragments after splitting. The split nodes meeting the first preset condition refer to splitting according to the key frames corresponding to the transition images, and the video time length of each fragment obtained after splitting satisfies the time length requirement (the time length requirement set by system or user, such as the time length requirement of 10 minutes to 15 minutes, so that the video time length of each video fragment is within this time length range). On the contrary, if no matter how to split according to the key frames corresponding to the transition images, a video fragment satisfying the time length requirement cannot be obtained, or if no transition image occurs in the video, then there is no split node meeting the first preset condition.

For example, for a two-hour video A, in order to satisfy requirements of the service scene, the preset time length range of a single fragment can be 15 minutes to 25 minutes. In a plurality of transition images of video A, suitable split nodes are selected, so that the video time length of each video fragment after video splitting is performed according to the split nodes is within the range of 15 minutes to 25 minutes. For example, the video is split into four video fragments, the time length of video fragment 1 is 17 minutes, the time length of video fragment 2 is 18 minutes, the time length of video fragment 3 is 22 minutes, and the time length of video fragment 4 is 16 minutes. These four video fragments are all obtained by splitting based on the key frames corresponding to the transition images in the video.

However, in actual applications, it cannot determine if the split nodes meeting the above-mentioned first preset condition can be obtained. Therefore, in order to realize the video splitting as reasonably as possible, optionally, if no suitable split nodes are found, then image judgement can be performed. Accordingly, the above-mentioned determining the split nodes according to the key frames corresponding to the transition images and a preset time length range of a single fragment can specifically further include: if it cannot determine that the split nodes meeting the first preset condition are obtained, then determining split nodes meeting a second preset condition as split nodes of the video according to key frames with an image change amplitude less than a third preset threshold and/or a sound change amplitude less than a fourth preset threshold, so that a video time length of each video fragment obtained by splitting according to the split nodes meeting the second preset condition is within the preset time length range.

In the present embodiment, whether meeting the second preset condition can be judged by referring to the key frames with a relatively static image change and/or a relatively spaced apart sound change in combination with the time length of the video fragments after splitting. The split nodes meeting the second preset condition refer to splitting according to the corresponding key frames with the relatively static image and/or the relatively spaced apart sound change, and the video time length of each fragment obtained after splitting satisfies the time length requirement, which can be the same as the time length requirement when judgement is made under the first preset condition. For example, the key frames corresponding to the transition images can be used as the split reference preferably, and if there is no key frame corresponding to the transition image within a suitable split time (that is, the video fragment obtained by splitting satisfies the time length requirement), then the split nodes meeting the second preset condition will be determined as split node of the video, that is, the key frames with a relatively static image change and/or a relatively spaced apart sound change are found for video splitting within the suitable split time (that is, the video fragment obtained by splitting satisfies the time length requirement).

For example, for a two-hour video A, in order to satisfy requirements of the service scene, the preset time length range of a single fragment can be 15 minutes to 25 minutes. If it is impossible to select suitable split nodes in a plurality of transition images of video A so that the video time length of each video fragment after splitting is within the range of 15 minutes to 25 minutes, then the image judgement can be performed, and the suitable split nodes can be selected according to the key frames with the image change amplitude less than a certain threshold (such as the relatively static image change) and/or the sound change amplitude less than a certain threshold (such as the relatively spaced apart sound change), so that the video time length of each video fragment after video splitting performed according to the split nodes is within the range of 15 minutes to 25 minutes.

In this optional way, if there is no transition scene within a suitable split time, points with a relatively static image change and a relatively spaced apart sound change can also be found to perform video splitting, which ensures that the video can be split as reasonably as possible, and thus ensures the viewing experience of users when viewing the video as much as possible.

In actual applications, when a content lit moment, a highlight moment, or the like occurs in the video, there may be a transition image. At this time, if video splitting is performed according to the transition image, a continuous content item belonging to these situations is likely to be inappropriately truncated, which will thus affect the user's viewing experience. Therefore, in order to solve this problem, optionally, step 202 can specifically include: firstly, filtering out key frames corresponding to transition images that meet a preset highlight moment condition based on the content item of the video; then, determining split nodes of the video according to the remaining key frames corresponding to the transition images after filtering.

The transition image meeting the preset highlight moment condition can be a transition image whose content item belongs to a lit moment, a highlight time, or the like. In the present embodiment, a corresponding machine learning model can be trained by utilizing sample video data with a lit moment, a highlight moment or the like in advance, and then the machine learning model can be used to obtain video frames meeting a lit moment, a highlight moment, or the like in the target video. Thus, when the split nodes of the video are determined, the key frames corresponding to the transition images meeting these situations are filtered out first, and then the split nodes of the video are determined according to the remaining key frames corresponding to the transition images after filtering.

In this optional way, it is ensured that the video can be split as reasonably as possible, and thus the user's viewing experience when viewing the video can be ensured as much as possible, so that the story can be coherently displayed when the user views the video content with a lit moment, a highlight moment or the like.

Step 203, splitting the video according to the split nodes of the video so as to obtain video fragments.

For the present embodiment, the user's requirement of manually selecting the split nodes can also be satisfied. Optionally, step 203 can specifically include: firstly, in the process of marking the split nodes by a video publisher, the recommended split nodes of the video are displayed according to the split nodes determined in step 202, and the video publisher can select the nodes for splitting according to his own desire (for example, the video author can also set, by himself, the time nodes he desires for splitting) or select the split nodes recommended in step 202 for video splitting (for example, in the process of marking the split nodes by the author himself, a corresponding suggestion will be given by executing the method shown in steps 201 to 202 for the author to decide whether to use the recommended node locations); then, according to the split nodes confirmed by the video publisher, the video is split to obtain video fragments. In this optional way, when the user manually selects the split nodes, a reasonable video splitting suggestion can also be given, which improves the efficiency when the user manually splits the video.

In the present embodiment, after video fragments are obtained by splitting, video parallel processing can be performed based on these video fragments, and the process shown in steps 204 to 206 can be specifically executed.

Step 204: performing parallel transcoding on the video fragments obtained by splitting according to a preset code rate and a preset resolution.

Based on the service scene, a different distributer has a respective combination of preset code rates and combination of preset resolutions. For example, different distributers, such as personal computer (PC), smart phone, tablet computer, television and the like, will have default recommended code rates and resolutions. When transcoding, a different suitable combination will be selected according to the service scene to transcode to the corresponding code streams. For example, there are six code rates and eight resolutions. According to service scene a, the corresponding distributer is the smart phone, it is possible to select three specific code rates from the six code rates and select four specific resolutions from the eight resolutions to perform parallel transcoding on the video fragments to obtain the corresponding code streams.

Illustratively, as shown in FIG. 3, the video processing chain can include: frame extraction, transcoding, detection process, recommendation engine, client player and other links. For the frame extraction and transcoding process in the related art, with the increase in the video time length, the number of extracted frames increases and the transcoding time becomes longer, which increases the computational power requirement, resource consumption, time, and the like for the machine model and is more likely to lead to failures and lead to retry or transcoding failure. In contrast, by using the frame extraction and transcoding process in the present embodiment (such as the process shown in steps 201 to 204), the processing efficiency of frame extraction and transcoding can be effectively improved.

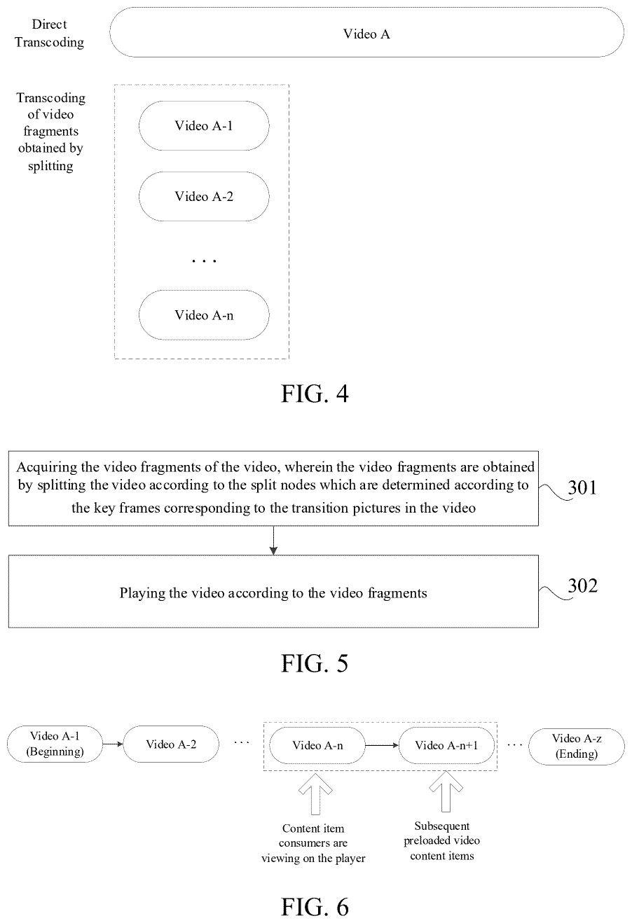

For example, as shown in FIG. 4, when transcoding, video fragments A-1, A-2 . . . . A-n obtained by splitting a long video will be subject to parallel transcoding according to a unified preset code rate and preset resolution. Compared with the case of no splitting, parallel transcoding can be performed after splitting, which improves the transcoding efficiency, reduces the failure probability and saves the transcoding time.

Step 205, sending the video fragments to a detection module for parallel detection processing.

The detection module can detect whether the video content has an abnormal content item, etc. As shown in FIG. 3, in the traditional way, a long video content item needs to be subject to content detection for a long time, more feature points are extracted, and a longer calculation time and comparison time are needed.

By adopting the detection optimization process in the present embodiment, a long video is split into several short videos, so that the parallel detection processing of a plurality of short videos can be achieved, and the detection efficiency is effectively improved.

Step 206, recommending to users video fragment content items corresponding to the video fragments and/or a video content item generated by combining the video fragments.

As shown in FIG. 3, for the processing link of recommendation engine, when distributing and recommending super-long videos at present, a poor distribution effect may be caused by a lower completion rate of super-long videos compared with short videos. In contrast, in the video recommendation way of the present embodiment, the long video can be split into short videos for recommendation, which can effectively solve this technical problem.

In the present embodiment, it is possible to recommend to users video fragment content items corresponding to the video fragments and/or a video content item generated by combining the video fragments, such as a whole video generated by combining all the video fragments, or a portion of the video generated by combining a portion of the video fragments, etc., so as to satisfy different requirements of users.

Illustratively, recommending to users video fragment content items corresponding to the video fragments can specifically include: acquiring video fragment content items corresponding to video fragments; selecting to recommend to users from a beginning fragment content item among the video fragment content items, or selecting to recommend to users from a fragment content item meeting a preset highlight moment condition among the video fragment content items.

This optional way can be adjusted based on different algorithms. For example, video A is split into video A-0 (beginning), video A-1, video A-2 (highlight moment), . . . video A-z (ending). According to the users' viewing requirements, recommendations can be made to users from the beginning, that is, from a video fragment content item corresponding to video A-0, or from an essence fragment (such as a lit moment, a highlight moment, etc.), for example, from video A-2. For the process of judging whether the video fragment is an essence fragment, reference can be made to the process of judging whether the preset highlight moment condition is met in step 202. In the present embodiment, the video fragment obtained by splitting can also be marked as to whether it is an essence fragment. In this optional way, the recommendation effect of video content items can be improved.

In the technical solution of the present embodiment, by reasonable video splitting, a video with a long time length, a large code rate and a large file size is split into videos with a short time length, unchanged or compressed code rate (depending on the selection of the user who uploads the video), and a reduced file size. Combining with the various links of frame extraction, transcoding, detection process, recommendation engine, and client player, the video processing efficiency after splitting is optimized and the final playback effect is optimized as a whole, thus improving the efficiency of the whole flow and reducing the probability of occurrence of jamming and abnormal failure without affecting the user experience of end content consumers.

As shown in FIG. 3, for the processing link of the client player, for a video with a long time length, a large bit rate and a large file size, it needs to be loaded by the player at one time, so that a high performance is required. If a content consumer has an average network speed, browser performance, and computer/mobile/tablet performance, then a bad playback experience may be caused. In order to solve this technical problem, further, the present embodiment also provides a video processing method as shown in FIG. 5, which can be applied to a client side, the method including:

Step 301, acquiring the video fragments of the video.

The video fragments can be obtained by splitting the video according to the split nodes which are determined according to the key frames corresponding to the transition images in the video. For details, please refer to the method shown in FIGS. 1 and 2.

Step 302, playing the video according to the video fragments.

According to the actual situation selected by users for playback, it is possible to play a complete video, or video fragment content items corresponding to the video fragments, or the like.

Optionally, step 302 can specifically include: preloading a video fragment content item of the (n+1)-th fragment when playing a video fragment content item of the n-th fragment among the video fragments, wherein the n-th fragment is any one of the video fragments, and the (n+1)-th fragment is a next fragment of the n-th fragment.

In the current related art, the video can also be directly split, for example, in the way of TV series, that is, one episode per preset time length. However, this way will affect the consumption experience of end users when the video is played, which causes discontinuity of users' consumption for long video content items. In contrast, in the video splitting way in the present embodiment, when the client player plays this kind of video with split nodes, the split nodes will not be perceived at the content consumer side, as different from the traditional concept of TV series.

For example, as shown in FIG. 6, when users view a complete video through the method of the present embodiment, the player will automatically preload the subsequent node A-n+1 when playing node A-n so as to ensure the coherence of playback. In this way, the client player has no need to load all the video data at one time, but only load the current video fragment and preload a next video fragment so as to ensure the coherence of the video, and automatically preload a further next video fragment when viewing the video content item of the next video fragment, and so on. The performance requirements for the client player are effectively reduced. For videos with a long time length, a large bit rate and a large file size, the improvement effect is more obvious, and the user's experience for video playback can be improved.

Further optionally, step 301 can specifically include: acquiring, in response to a user's instruction to adjust a playback progress of the video, a target video fragment corresponding to a progress position specified by the user and a next fragment of the target video fragment. Accordingly, step 302 can specifically include: playing a video fragment content item of the target video fragment, and preloading a video fragment content item of a next fragment of the target video fragment.

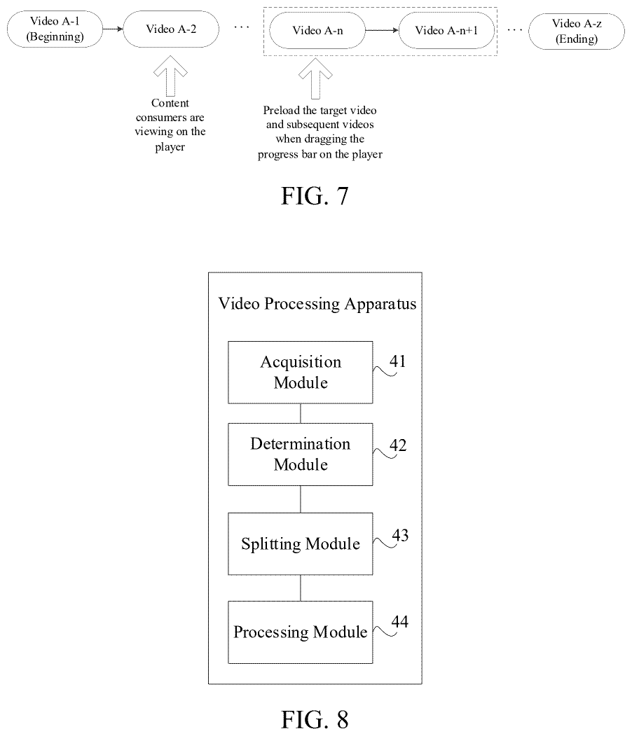

For example, as shown in FIG. 7, when the user drags the video playback progress on the progress bar, unnecessary intermediate nodes can be skipped. For example, the user is currently viewing the video content item of video fragment 2 and then adjusts the video playback progress to correspond to the video content item of video fragment 5, and the client player can download and play the video content item of video fragment 5 and preload the video content item of video fragment 6 (if there is video fragment 6), without downloading the video content items of video fragments 3 and 4. In this optional way, the number of videos to be downloaded is saved, and a good playback fluency can be ensured even when the network speed, browser performance and hardware device performance are pretty average.

In the present embodiment, through the optimization of each link (as shown in FIG. 3), after the video author uploads a video with a long time length, and/or a large code rate and/or a large file size, the video platform can present this video to the end content consumers more quickly, and the content consumers will not feel that the video content items are discontinuous or the viewing experience is reduced as in the traditional simple mode of split episodes.

Further, as a specific implementation of the method shown in FIGS. 1 and 2, the present embodiment provides a video processing apparatus as shown in FIG. 8, which can be applied to a server. The apparatus includes: an acquisition module 41, a determination module 42, a splitting module 43 and a processing module 44.

The acquisition module 41 is configured to acquire key frames corresponding to transition images in a video;
the determination module 42 is configured to determine split nodes of the video according to the key frames corresponding to the transition images;
the splitting module 43 is configured to split the video according to the split nodes of the video so as to obtain video fragments;
the processing module 44 is configured to perform video parallel processing on the basis of the video fragments.

In a specific application scene, the acquisition module 41 is specifically configured to determine the key frames corresponding to the transition images by analyzing a color change degree and a color family change degree of two adjacent frames among video frames.

In a specific application scene, the acquisition module 41 is specifically further configured to compare a color value corresponding to each pixel point in a current frame and in a previous frame; if it is judged according to a comparison result of the color value that the current frame and the previous frame have a color change rate greater than a first preset threshold and a color family change meeting a preset span condition, then determine the key frame corresponding to the transition image according to the current frame.

In a specific application scene, the acquisition module 41 is specifically further configured to determine, if each of a predetermined number of frames following the current frame and the previous frame have a color change rate greater than a second preset threshold and a color family change meeting a preset span condition, the current frame as a key frame corresponding to the transition image.

In a specific application scene, the determination module 42 is specifically configured to determine the split nodes of the video according to the key frames corresponding to the transition images and a preset time length range of each fragment.

In a specific application scene, the determination module 42 is specifically further configured to determine, based on the key frames corresponding to the transition images, split nodes meeting a first preset condition as split nodes of the video, so that a video time length of each video fragment obtained by splitting according to the split nodes meeting the first preset condition is within the preset time length range.

In a specific application scene, the determination module 42 is specifically further configured to determine, if it cannot determine that the split nodes meeting the first preset condition are obtained, split nodes meeting a second preset condition as split nodes of the video according to key frames with an image change amplitude less than a third preset threshold and/or a sound change amplitude less than a fourth preset threshold, so that a video time length of each video fragment obtained by splitting according to the split nodes meeting the second preset condition is within the preset time length range.

In a specific application scene, the determination module 42 is specifically further configured to filter out key frames corresponding to transition images that meet a preset highlight moment condition; determine split nodes of the video according to the remaining key frames corresponding to the transition images after filtering.

In a specific application scene, the splitting module 43 is specifically configured to display recommended split nodes of the video according to the determined split nodes of the video, in the process of marking the split nodes by the video publisher; split the video according to the split nodes confirmed by the video publisher so as to obtain video fragments.

In a specific application scene, the processing module 44 is specifically configured to perform parallel transcoding on the video fragments according to a preset code rate and a preset resolution, wherein a different distributer has a respective combination of preset code rates and combination of preset resolutions.

In a specific application scene, the processing module 44 is specifically further configured to send the video fragments to the detection module for parallel detection processing.

In a specific application scene, the processing module 44 is specifically further configured to recommend to users video fragment content items corresponding to the video fragments and/or a video content item generated by combining the video fragments.

In a specific application scene, the processing module 44 is specifically further configured to acquire video fragment content items corresponding respectively to video fragments; select to recommend to users from a beginning fragment content item among the video fragment content items, or select to recommend to users from a fragment content item meeting a preset highlight moment condition among the video fragment content items.

It should be noted that other corresponding descriptions of the functional units involved in the video processing apparatus provided by the present embodiment, which can be applied to the server, can refer to the corresponding descriptions in FIG. 1 and FIG. 2, and are not repeated here.

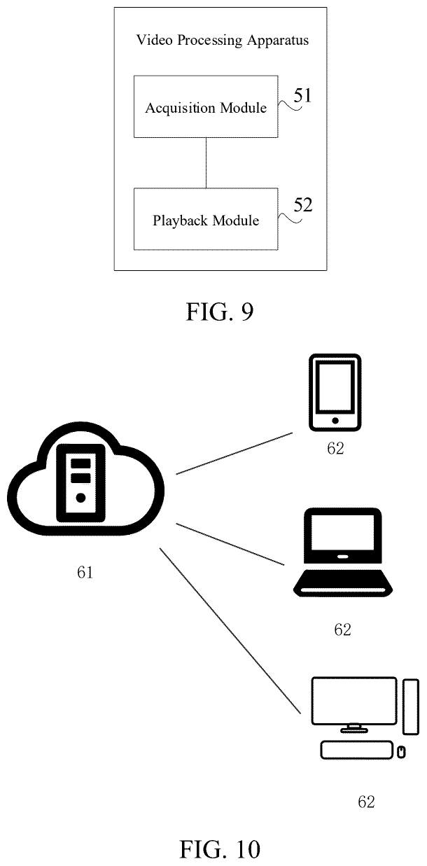

Further, as a specific implementation of the method shown in FIG. 5, the present embodiment provides a video processing apparatus as shown in FIG. 9, which can be applied to a client. The apparatus includes: an acquisition module 51 and a playback module 52.

The acquisition module 51 is configured to acquire video fragments of a video, wherein the video fragments are obtained by splitting the video according to split nodes which are determined according to key frames corresponding to transition images in the video;

the playback module 52 is configured to play the video according to the video fragments.

In a specific application scene, the playback module 52 is specifically configured to preload a video fragment content item of the (n+1)-th fragment when playing a video fragment content item of the n-th fragment among the video fragments, wherein the n-th fragment is any of the video fragments, and the (n+1)-th fragment is a next fragment of the n-th fragment.

In a specific application scene, the acquisition module 51 is specifically configured to acquire, in response to a user's instruction to adjust a playback progress of the video, a target video fragment corresponding to a progress position specified by the user and a next fragment of the target video fragment;
correspondingly, the playback module 52 is specifically configured to play a video fragment content item of the target video fragment, and preload a video fragment content item of a next fragment of the target video fragment.

It should be noted that other corresponding descriptions of various functional units involved in the video processing apparatus provided by the present embodiment, which can be applied to a client, can refer to the corresponding description in FIG. 5, and are not repeated here.

Based on the above-mentioned methods shown in FIGS. 1 and 2, correspondingly, the present embodiment further provides a computer readable storage medium storing thereon a computer program which, when executed by a processor, implements the above-mentioned methods shown in FIGS. 1 and 2.

Based on the above-mentioned method shown in FIG. 5, correspondingly, the present embodiment further provides another computer readable storage medium storing thereon a computer program which, when executed by a processor, implements the above-mentioned method shown in FIG. 5.

Based on the above-mentioned methods shown in FIGS. 1 and 2, correspondingly, the present embodiment further provides a computer program product, which is stored in a storage medium. When the computer program product is executed by a computer device, the computer device executes the video processing method shown in FIGS. 1 and 2.

Based on the above-mentioned method shown in FIG. 5, correspondingly, the present embodiment further provides another computer program product, which is stored in a storage medium. When the computer program product is executed by a computer device, the computer device executes the video processing method shown in FIG. 5.

Based on such understanding, the technical solution of the present disclosure can be embodied in the form of a software product, which can be stored in a non-volatile storage medium (which can be a CD-ROM, a USB flash drive, a mobile hard disk, etc.) and includes several instructions to cause a computer device (which can be a personal computer, a server, or a network device, etc.) to execute the method of various implementation scenes of the present disclosure.

Based on the above-mentioned methods shown in FIGS. 1 and 2 and the virtual apparatus embodiment shown in FIG. 8, in order to achieve the above purpose, an embodiment of the present disclosure further provides an electronic device, such as a server, which includes a storage medium for storing a computer program, and a processor for executing the computer program to implement the above-mentioned methods as shown in FIGS. 1 and 2.

Based on the above-mentioned method shown in FIG. 5 and the virtual apparatus embodiment shown in FIG. 9, in order to achieve the above purpose, an embodiment of the present disclosure further provides another electronic device, such as a client device, specifically a smart phone, a personal computer, a tablet computer, etc., which includes a storage medium for storing a computer program, and a processor for executing the computer program to implement the above-mentioned method as shown in FIG. 5.

It can be understood by those skilled in the art that the above-mentioned two entity device structures provided by the present embodiment do not constitute limitations on the entity device, and can include more or less components, or combine some components, or have different component arrangements.

The storage medium can also include an operating system and a network communication module. The operating system is a program that manages hardware and software resources of the above-mentioned entity device, and supports the operation of information processing programs and other software and/or programs. The network communication module is used for realizing the communication between the components within the storage medium and the communication with other hardware and software in the information processing entity device.

Based on the above, further, the present embodiment further provides a video processing system, as shown in FIG. 10, which includes: a server 61 and a client device 62.

The server 61 can be used for executing the methods shown in FIGS. 1 and 2, and the client device 62 can be used for executing the method shown in FIG. 5.

The server device 61 can be used for first acquiring key frames corresponding to transition images in a video after the video author uploads the video; determining split nodes of the video according to the key frames corresponding to the transition images; then splitting the video according to the split nodes so as to obtain video fragments; subsequently performing video parallel processing on the basis of the video fragments, and recommending to users the video according to the processed video fragments.

The client device 62 can be used for acquiring video fragments of the video when the user needs to view the video recommended by the server device 61, wherein the video fragments are obtained by splitting the video according to the split nodes which are determined according to the key frames corresponding to the transition images in the video; then playing the video according to the video fragments.

Through the description of the above implementation, those skilled in the art can clearly understand that the present embodiment can be implemented by means of software and necessary general hardware platform, or by hardware. With the above technical solution, by comparing the video processing method and apparatus and an electronic device provided by the present disclosure with the current related art, the present disclosure can effectively mitigate the technical problem of low video processing efficiency and high resource consumption present when processing videos with a long time length, a large code rate and a large file size, which are updated by the video author. Specifically, it is possible to first determine split nodes of the video according to the key frames corresponding to the transition images in the video; then split the video according to the split nodes to obtain video fragments, so as to realize the reasonable video splitting, and split a video with a long time length, a large code rate and a large file size into video fragments with a short time length, unchanged or compressed code rate and a small file size; then perform video parallel processing based on these video fragments, which can optimize all links in the video processing chain, greatly improve the video processing efficiency, and obviously save the resource consumption. By applying the technical solution of the present disclosure, the processing effect of the whole process from video uploading and publication to final video playback can be optimized as a whole, so that the efficiency of the whole video processing flow is improved and the probability of video jamming and abnormal failure is reduced without affecting the user experience of end content consumers.

It should be noted that, relational terms such as “first” and “second” herein are only used to distinguish one entity or operation from another entity or operation, and do not necessarily require or imply that there is any such actual relationship or order between these entities or operations. Moreover, the terms “including”, “comprising” or any other variation thereof are intended to cover non-exclusive inclusion, so that a process, method, article or device including a series of elements includes not only those elements, but also other elements not explicitly listed or elements inherent to such process, method, article or device. Without further restrictions, an element defined by the sentence “including a . . . ” does not exclude the presence of additional identical elements in the process, method, article or device including the element.

What has been described above is only the specific implementations of the present disclosure, so that those skilled in the art can understand or implement the present disclosure. Many modifications to these embodiments will be obvious to those skilled in the art, and the general principles defined herein can be implemented in other embodiments without departing from the spirit or scope of the present disclosure. Therefore, the present disclosure will not be limited to these embodiments described herein, but is to be accorded the widest scope consistent with the principles and novel features disclosed herein.

1. A video processing method, comprising:
acquiring key frames corresponding to transition images in a video;
determining split nodes of the video according to the key frames corresponding to the transition images;
splitting the video according to the split nodes of the video so as to obtain video fragments;
performing video parallel processing on the basis of the video fragments.

2. The video processing method according to claim 1, wherein the acquiring key frames corresponding to transition images in a video comprises:
determining the key frames corresponding to the transition images by analyzing a color change degree and a color family change degree of two adjacent frames among video frames.

3. The video processing method according to claim 2, wherein the determining the key frames corresponding to the transition images by analyzing a color change degree and a color family change degree of two adjacent frames among video frames comprises:
comparing a color value corresponding to each pixel point in a current frame and in a previous frame;
if it is judged according to a comparison result of the color value that the current frame and the previous frame have a color change rate greater than a first preset threshold and a color family change meeting a preset span condition, then determining the key frame corresponding to the transition image according to the current frame.

4. The video processing method according to claim 3, wherein the determining the key frame corresponding to the transition image according to the current frame comprises:
if each of a predetermined number of frames following the current frame and said previous frame have a color change rate greater than a second preset threshold and a color family change meeting the preset span condition, then determining the current frame as the key frame corresponding to the transition image.

5. The video processing method according to claim 1, wherein the determining split nodes of the video according to the key frames corresponding to the transition images comprises:
determining the split nodes of the video according to the key frames corresponding to the transition images and a preset time length range of each fragment.

6. The video processing method according to claim 5, wherein the determining the split nodes of the video according to the key frames corresponding to the transition images and a preset time length range of each fragment comprises:
determining, based on the key frames corresponding to the transition images, split nodes meeting a first preset condition as split nodes of the video, so that a video time length of each video fragment obtained by splitting according to the split nodes meeting the first preset condition is within the preset time length range.

7. The video processing method according to claim 6, wherein the determining the split nodes of the video according to the key frames corresponding to the transition images and a preset time length range of each fragment further comprises:
if it can not determine that the split nodes meeting the first preset condition are obtained, then determining split nodes meeting a second preset condition as split nodes of the video according to key frames with at least one of an image change amplitude less than a third preset threshold or a sound change amplitude less than a fourth preset threshold, so that a video time length of each video fragment obtained by splitting according to the split nodes meeting the second preset condition is within the preset time length range.

8. The video processing method according to claim 1, wherein the determining split nodes of the video according to the key frames corresponding to the transition images comprises:
filtering out key frames corresponding to transition images that meet a preset highlight moment condition;
determining split nodes of the video according to the remaining key frames corresponding to the transition images after filtering.

9. The video processing method according to claim 1, wherein the splitting the video according to the split nodes of the video so as to obtain video fragments comprises:
displaying recommended split nodes of the video according to the determined split nodes of the video;
splitting the video according to split nodes confirmed by a video publisher so as to obtain video fragments.

10. The video processing method according to claim 1, wherein the performing video parallel processing on the basis of the video fragments comprises:
acquiring video fragment content items respectively corresponding to the video fragments;
selecting to recommend to a user from a beginning fragment content item among the video fragment content items, or recommend to a user from a fragment content item meeting a preset highlight moment condition among the video fragment content items.

11. A video processing method, comprising:
acquiring video fragments of a video, wherein the video fragments are obtained by splitting the video according to split nodes which are determined according to key frames corresponding to transition images in the video;
playing the video according to the video fragments.

12. The video processing method according to claim 11, wherein the playing the video according to the video fragments comprises:
preloading a video fragment content item of the (n+1)-th fragment among the video when playing a video fragment content item of the n-th fragment, wherein the n-th fragment is any one of the video fragments, and the (n+1)-th fragment is a next fragment of the n-th fragment.

13. The video processing method according to claim 12, wherein the acquiring video fragments of a video comprises:
acquiring, in response to a user's instruction to adjust a playback progress of the video, a target video fragment corresponding to a progress position specified by the user and a next fragment of the target video fragment;
the playing the video according to the video fragments further comprises:
playing a video fragment content item of the target video fragment, and preloading a video fragment content item of a next fragment of the target video fragment.

14-15. (canceled)

16. A non-transitory computer readable storage medium storing therein computer executable instructions, wherein a processor, when executing the computer executable instructions, implements a video processing method comprising:
acquiring key frames corresponding to transition images in a video;
determining split nodes of the video according to the key frames corresponding to the transition images;
splitting the video according to the split nodes of the video so as to obtain video fragments;
performing video parallel processing on the basis of the video fragments.

17. An electronic device, comprising:
a processor and a memory;
the memory storing computer executable instructions;
the processor executing the computer executable instructions stored in the memory, so that the processor executes the video processing method according to claim 1.

18-19. (canceled)

20. The non-transitory computer readable storage medium according to claim 16, wherein the acquiring key frames corresponding to transition images in a video comprises:
determining the key frames corresponding to the transition images by analyzing a color change degree and a color family change degree of two adjacent frames among video frames.

21. The non-transitory computer readable storage medium according to claim 20, wherein the determining the key frames corresponding to the transition images by analyzing a color change degree and a color family change degree of two adjacent frames among video frames comprises:
comparing a color value corresponding to each pixel point in a current frame and in a previous frame;
if it is judged according to a comparison result of the color value that the current frame and the previous frame have a color change rate greater than a first preset threshold and a color family change meeting a preset span condition, then determining the key frame corresponding to the transition image according to the current frame.

22. The non-transitory computer readable storage medium according to claim 21, wherein the determining the key frame corresponding to the transition image according to the current frame comprises:
if each of a predetermined number of frames following the current frame and said previous frame have a color change rate greater than a second preset threshold and a color family change meeting the preset span condition, then determining the current frame as the key frame corresponding to the transition image.

23. A non-transitory computer readable storage medium storing therein computer executable instructions, wherein a processor, when executing the computer executable instructions, implements the video processing method according to claim 11.

24. An electronic device, comprising:
a processor and a memory;
the memory storing computer executable instructions;
the processor executing the computer executable instructions stored in the memory, so that the processor executes the video processing method according to claim 11.
